(19) United States
(12) Patent Application Publication
(10) Pub. No.: US 2017/0168291 A1
(43) Pub. Date: Jun. 15, 2017

(54) CAMERA UNIT WITH A CLEANING DEVICE

(71) Applicant: Huf Huelsbeck & Fuerst GmbH & Co. KG, Velbert (DE)

(72) Inventor: Wolfgang Buss, Solingen (DE)

(21) Appl. No.: 15/373,188

(22) Filed: Dec. 8, 2016

(30) Foreign Application Priority Data
Dec. 9, 2015 (DE) 102015121434.2

(51) Int. Cl. G02B 27/00; B60S 1/66; B08B 3/02; H04N 7/18; H04N 5/225

(52) U.S. Cl. CPC G02B 27/0006; H04N 7/183; H04N 5/2252; B08B 3/02; B60S 1/66

(57) ABSTRACT

The invention concerns a camera unit for image acquisition of an outside area for a motor vehicle having a cleaning device provided for cleaning the camera unit.

### CROSS REFERENCE TO RELATED APPLICATIONS

This application claims the benefit of priority to German Patent Application No. 10 2015 121 434.2, filed on Dec. 9, 2015, the disclosure of which is incorporated herein by reference in its entirety.

### FIELD

The invention concerns a camera unit for image acquisition of an outside area for a motor vehicle having a cleaning device provided for cleaning the camera unit, wherein the cleaning device includes a control element for driving a movable component, in particular a piston. In addition, the cleaning device has a housing for accommodating the movable component, wherein at least one inlet and at least one outlet, each of which is provided with a check valve, is associated with the housing. In addition, the cleaning device includes a cleaning element, in particular a cleaning nozzle, connected to at least one outlet, in order to apply at least one fluid to the camera unit. Through the motion of the movable component, the fluid can be transported from the inlet to the outlet in order to clean the camera unit with the cleaning element.

### BACKGROUND

From the prior art, a camera unit is known that has a cleaning device associated therewith. The cleaning device includes a housing, wherein the housing has two chambers that are each provided with the same fill volume. Air is located in the first chamber, and water is located in the second chamber. It has become apparent that less air or water is required for the cleaning process depending on the mechanical design of the camera unit.

Consequently, the object of the invention is to provide a camera unit having a cleaning device that continues to achieve a satisfactory cleaning result through simple design measures.

The object of the invention is attained by the means that the housing includes at least two chambers, wherein a first chamber has a greater fill volume than a second chamber.

The camera unit with the cleaning device has the advantage that simple design means suffice to clean the camera unit, in particular a lens of the camera unit. The basic principle for transporting the fluid to the lens resembles the functioning of an air pump. By means of the movable component, which is designed as a piston or a screw, the fluid is drawn into the chamber through an inlet and conveyed or pumped to the cleaning device through the outlet. The only additional requirement is a control element, which sets the movable component in motion. The check valves, which can, for example, be located in or ahead of inlet and/or outlet lines, in particular flexible lines, ensure that when the fluid is drawn in or transported, the fluid can only be carried either out of the chamber or into the chamber. A simultaneous drawing in and conveying or pumping out of the same fluid in a self-contained chamber section of the first or second chamber is thus precluded by the movable component so that reliable and precise cleaning of the camera unit, in particular of the lens, is always ensured. By means of this mechanical principle, the construction costs of the camera unit and of the cleaning device are advantageously reduced.

As already described, the first chamber has a greater fill volume than the second chamber, so consumption of the fluid in the second chamber can be reduced. This is advantageous when only a small installation space is available to house the camera unit and/or the cleaning device. At the same time, the consumption of the fluid in the first chamber is higher. If, for example, air is located in the first chamber and water is located in the second chamber, then the drying process, in particular the process of drying a lens, can be improved, because more air than water is available with respect to the volume. If more water is required than air, the arrangement of the fluids in the chambers is changed so that water is supplied to the first chamber and air is supplied to the second chamber. Of course, provision can also be made for the same fluid to be located in both of the two chambers.

### SUMMARY

According to a preferred embodiment of the camera unit, provision can be made that, as a result of the motion of the movable component in the first chamber, an underpressure can be created that draws the fluid into the first chamber through at least one first inlet, and upon a subsequent motion of the movable component conveys the fluid out of the first chamber through a first outlet to a cleaning element in order to expose the camera unit, in particular a lens of the camera unit, to the fluid, in particular air. This measure ensures that sufficient fluid, in particular water and/or air, is always available in the chambers to carry out cleaning of the camera unit. Consequently, droplets or moisture present on the camera unit, in particular on the lens, can be eliminated with the air flowing out of the cleaning element. As a result, the images taken are displayed more clearly, distinctly, and precisely on a screen associated with the motor vehicle.

In order to save energy when the control element is moved, provision can be made for at least one additional vent opening, which serves to fill and empty the first chamber with air, to be provided in the first chamber.

According to a preferred embodiment of the camera unit, provision can be made that, as a result of the motion of the movable component in the second chamber, an underpressure can be created that draws the fluid into the second chamber through at least one second inlet, and upon a subsequent motion of the movable component the fluid is conveyed out of the second chamber through the second outlet to the cleaning element in order to expose the camera unit, in particular a lens of the camera unit, to the fluid. It is advantageously ensured in this way that sufficient water is always available for cleaning the camera unit.

Cleaning of the camera unit becomes more efficient when the first chamber has a first inlet for a first fluid, in particular air, as well as a first outlet for the first fluid, and the second chamber has a second inlet for a second fluid, in particular water, as well as a second outlet for the second fluid, wherein the first chamber is used for disposition of the first fluid, in particular air, and the second chamber is used for disposition of the second fluid, in particular water.

The camera unit can be reliably cleaned and dried by only two strokes of the movable component when the movable component is designed to be movable between a first position, in particular rest position, and a second position, in particular cleaning position, wherein, during the motion from the first position to the second position, the first fluid, in particular water, can be transported through the second outlet to the cleaning element and the first fluid, in particular air, can be drawn in through the first inlet, and during the motion of the movable component from the second position to the first position, the second fluid, in particular water, can be drawn in through the second inlet and the first fluid, in particular air, can be transported to the cleaning element through the first outlet in order to dry the camera unit, in particular the lens. This measure makes it possible to dispense with an additional cost-intensive drying device, because the cleaning device provides two functions, namely cleaning and drying, in a single device.

A good cleaning result for the camera unit can be achieved when the first chamber is used for filling with air and the second chamber is used for filling with water.

The fluids can be transported to the cleaning device very reliably when the movable component has a first plate and a second plate, wherein the two plates are connected to one another by means of a connecting element. The design can have an economical and simple construction when the first plate is located in the first chamber and the second plate is located in the second chamber.

According to another preferred embodiment of the camera unit, provision can be made that the movable component, in particular the first plate and the second plate, is provided with one seal element apiece, wherein the first seal element is located between an inner wall of the first chamber and a plate wall of the first plate, and the second seal element is located between an inner wall of the second chamber and a plate wall of the second plate. By this means, it is advantageously possible to prevent fluid from one chamber getting into the other chamber during the motion of the control element. Mixing of the two fluids would lead to a poor cleaning result. In the case of drying the cleaning element, air with a relatively high humidity is used in the absence of a seal element.

The mechanical design can be simplified if the first outlet has, in particular, a first outlet line and the second outlet has, in particular, a second outlet line, wherein the first outlet line and the second outlet line are connected to one another after the applicable check valves and form a combined outlet, in particular a combined outlet line that is connected to the cleaning element. As a result, only a single line must be connected to the cleaning element. Consequently, it is only necessary to provide a single connection on the cleaning element. The assembly time for the cleaning device is shortened because fewer mechanical parts need to be installed for the cleaning device and/or camera device.

For compact accommodation of the camera unit and the cleaning device, provision can be made that the inlet line and/or the outlet line and/or the outlet and/or the inlet are made of a flexible material. Due to this design, it is advantageously possible for the housing and the cleaning element to be arranged at a distance from one another. Consequently, it is possible to locate the housing having the first chamber and the second chamber directly on the back of the housing of the camera unit, and to route or to bend the resilient or flexible line, preferably made of an elastomer, in particular of rubber, to a cleaning element spaced apart from the housing.

The energy consumption of the cleaning device, in particular of the control element or actuator implemented as an electric motor, is reduced when the movable component is connected to a spring element in order to automatically move the movable component by means of the preloaded spring element from the second position, in particular cleaning position, back to the first position, in particular rest position.

According to a preferred embodiment of the camera unit, provision can be made that the control element is implemented as an electric motor or actuator. The electric motor is economical to manufacture, and requires only very little installation space because of its compact construction.

According to a preferred embodiment of the camera unit, provision can be made that the cleaning device is connected to, in particular screwed to, the camera unit. In this way, it is possible to make a compact camera module that includes the camera unit and the cleaning device. The camera unit includes at least a camera housing, a camera having a lens, and a camera electronics unit for processing the images. The cleaning device includes at least one cleaning nozzle implemented as the cleaning element, which nozzle is connected to a chamber for accommodating the fluid. The camera housing itself can likewise be designed to accommodate an operating device for initiating an opening and/or closing motion of a lid or hatch of the motor vehicle. The camera unit having the lens is then located next to the operating device that is implemented, for example, as a mechanical or capacitive pushbutton. Alternatively, it is likewise possible to arrange the camera unit separately from the cleaning device.

The costs for manufacturing the camera unit are reduced when the cleaning element is arranged in a fixed position on a camera housing of the camera unit. It is likewise possible to arrange the cleaning element behind a protective lid that is movable as needed in order to uncover the cleaning element.

It is also alternatively possible to design the cleaning element to be movable such that it can travel into an installation space provided in the camera unit or in the vehicle body for this purpose. In this way, the cleaning element itself is protected from dirt when it is located in a protected region of the vehicle. The already existing control element for moving the movable component, in particular the piston, can be used to move the cleaning element, or else a separate control element can also be used.

In order to accelerate the process of cleaning the camera unit, provision is made that the second chamber is always at least partially filled with water prior to the start of the camera unit cleaning process.

The object of the invention is additionally attained by a method for cleaning a camera unit for image acquisition of an outside area for a motor vehicle, wherein a cleaning device that has a cleaning element and that serves to clean the camera unit with a fluid is associated with the camera unit, wherein the cleaning device has a control element that moves a movable component, in particular a piston, within a housing of the cleaning device, which housing is designed with at least one inlet and at least one outlet, wherein the fluid is moved from the inlet to the outlet by the motion of the movable component in order to clean and/or to dry the camera unit with the cleaning element, wherein the housing includes at least two chambers, wherein a first chamber has a greater fill volume for the fluid than a second chamber. This method ensures that the camera unit is cleaned reliably and economically without increasing the design or construction costs.

The process of cleaning the camera unit can be improved further if a fluid is drawn in through the inlet during the motion of the movable component and then upon a second motion is transported through the outlet to the cleaning element in order to clean and/or to dry the camera unit, in particular the lens of the camera unit, with the fluid.

When two different fluids are used, it can be very advantageous that the first chamber has a first inlet as well as a first outlet for a first fluid, in particular air, and that the second chamber has a second inlet as well as a second outlet for a second fluid, in particular water. Excellent cleaning and immediately subsequent good drying of the camera device, in particular the lens, can advantageously be achieved by the means that, when the movable component is designed to be movable between a first position, in particular rest position, and a second position, in particular cleaning position, wherein, during the motion from the first position to the second position, the second fluid, in particular water, can be transported through the second outlet to the cleaning element and the first fluid, in particular air, can be drawn in through the first inlet, and during the motion of the movable component from the second position to the first position, the second fluid, in particular water, can be drawn in through the second inlet and the first fluid, in particular air, can be transported to the cleaning element through the first outlet in order to dry the camera unit, in particular the lens.

The energy consumption of the cleaning device, in particular of the control element or actuator implemented as an electric motor, is reduced when a spring element connected to the movable component is preloaded by the control element during the movement from the first position, in particular the rest position, to the second position, in particular the cleaning position, and after the second chamber has been emptied of the fluid, in particular water, the movable component is automatically conveyed back from the second position to the first position by the preloaded spring element.

If the camera unit is to be clean and dry after the cleaning process is finished, then the camera unit is first exposed to water and then to air.

### BRIEF DESCRIPTION OF THE DRAWINGS

The invention is described using an exemplary embodiment. The figures show:

FIG. 1 a camera unit with a cleaning device in a perspective view from the front,

FIG. 2a a schematic diagram of the cleaning device in a rest position,

FIG. 2b the schematic diagram of the cleaning device in a phase from the rest position to the cleaning position,

FIG. 2c the schematic diagram of a cleaning device in a cleaning position, and

FIG. 2d the schematic diagram of a cleaning device in a phase from the cleaning position to the rest position.

### DETAILED DESCRIPTION

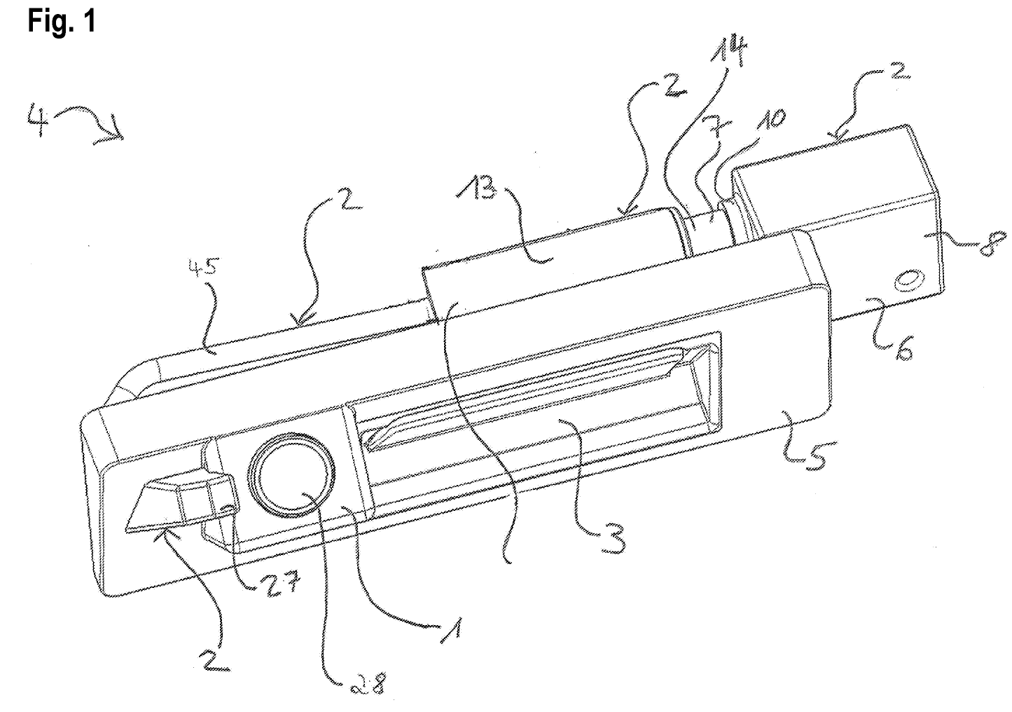

FIG. 1 illustrates a camera unit 1 according to the invention for image acquisition of an outside area for a motor vehicle having a cleaning device 2 provided for cleaning the camera unit 1. In the present case, the camera unit 1, the cleaning device 2, and an operating device 3 constitute a camera module 4, wherein the cleaning device 2 is rigidly attached, at least in part, to a camera housing 5 of the camera unit 1, in particular screwed thereto. It is also possible to arrange the cleaning device 2 so that it is spaced apart from the camera unit 1. It is not absolutely necessary for the camera unit 1 to be directly connected to the cleaning device 2. It is only necessary to ensure that the distance between the camera unit 1 and the cleaning device 2 is chosen such that the camera unit 1 is cleaned adequately. This can also be achieved by the means that, for example, the camera unit 1 and the cleaning device 2 are arranged at a distance from one another in support designed as a rear trim strip.

The cleaning device 2 includes a control element 6 implemented as an electric motor or actuator for driving a movable component 7 implemented as a piston. The essentially cylindrical movable component 7 is located at least partially inside a control element housing 8. In this design, the movable component 7 is guided and supported in an opening 9 of the control element housing 8. The opening 9 of the control element housing 8 is designed with a housing sealing element 10 implemented as an O-ring, which, on the one hand, serves to prevent entry of moisture into the control element housing 8, and, on the other hand, ensures that the movable component 7 is guided securely and without rattling.

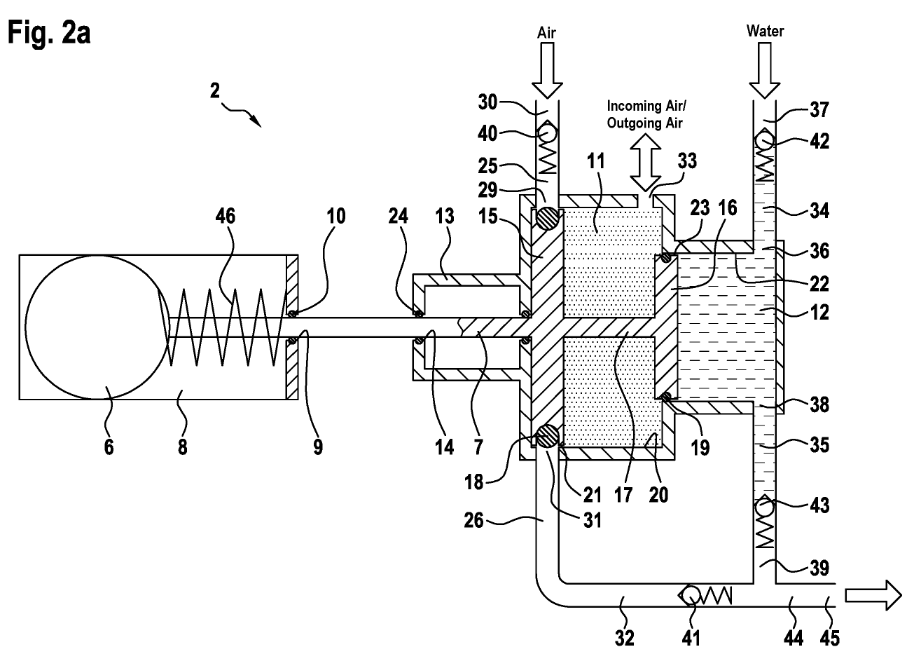

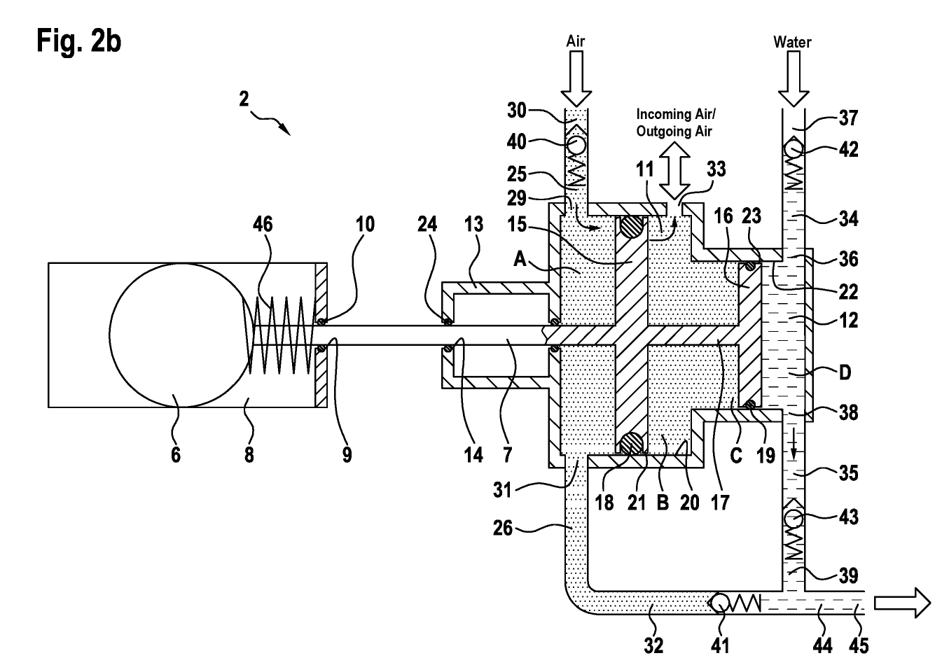

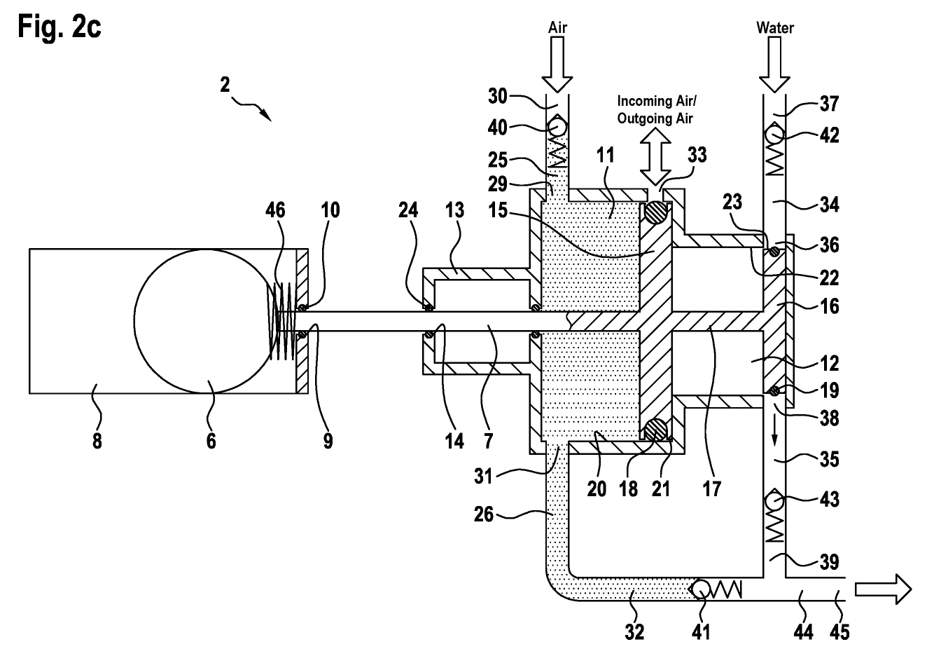

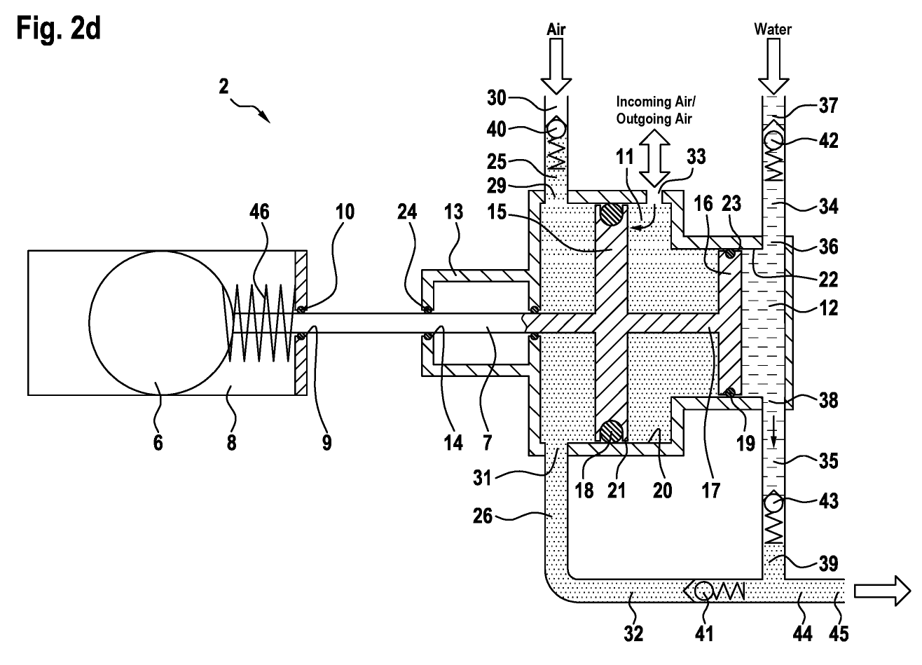

The cleaning device 2 is shown schematically in FIGS. 2a to 2d. The cleaning device 2 includes a first chamber 11 and a second chamber 12 that are located in a housing 13 with a chamber opening 14. The first chamber 11 serves to accommodate and hold a fluid, in particular air. The second chamber 12 is designed to accommodate and hold another fluid, in particular water. The two chambers 11, 12 also accommodate the movable component 7. According to the invention, the first chamber 11 has a greater fill volume than the second chamber 12, so that the drying process lasts longer and drying by the cleaning device is improved.

The movable component 7 has a first plate 15 and a second plate 16, wherein the two plates 15, 16 are connected to one another by means of a connecting element 17. The first plate 15 is located in the first chamber 11, and the second plate 16 is located in the second chamber 12. The first plate 15 is provided with a first seal element 18, and the second plate 16 is provided with a second seal element 19. The first seal element 18 is located between an inner wall 20 of the first chamber 11 and a plate wall 21 of the first plate 15. The second seal element 19 is located between an inner wall 22 of the second chamber 12 and a plate wall 23 of the second plate 16.

The movable component 7 is composed of a piston. The movable component 7 therefore has the connecting element 17 implemented as a cylindrical shank. The cylindrical connecting element 17 is supported and guided by both the control element housing 8 and the housing 12. Located between the chamber opening 14 and the cylindrical connecting element 17 of the movable component 7 is a sealing element 24 that serves to prevent any air from escaping from the first chamber 11 at this point in the housing 13.

The first plate 15 and the second plate 16, which are designed as a single piece with the cylindrical connecting element 17, are movably guided within the housing 13. During the motion of the movable component 7, the first chamber 11 is divided by the first plate 15 into a first chamber section A and a second chamber section B, and the second chamber 12 is divided by the second plate 16, at least some of the time, into a first chamber section C and a second chamber section D, as is shown in FIGS. 2b and 2d. The seal elements 18, 19 are now meant to prevent the different fluids from mixing in the chamber sections A, B, C, D.

As a result of the motion of the movable component 7 in the first chamber, an underpressure can be created that draws the fluid into the first chamber 11 through at least one first inlet 25, and upon a subsequent motion of the movable component 7 conveys the fluid out of the first chamber 11 through a first outlet 26 to a cleaning element 27 in order to expose the camera unit 1, in particular a lens 28 of the camera unit 1, to the fluid, in particular air. The first inlet 25 is connected to a flexible inlet line 30 at a first inlet port 29. The first inlet line 30 is connected in a sealed manner by an inlet connecting element, not shown, to the first inlet port 29.

The first outlet 26 is connected to a flexible first outlet line 32 at a first outlet port 31. The first outlet line 32 is likewise connected in a sealed manner by an outlet connecting element, not shown, to the first outlet port 31.

In addition, at least one additional vent opening 33, which serves to fill and empty the first chamber 11 with air while the movable component 7 moves, is provided in the first chamber 11.

If one now considers the second chamber 12, an underpressure can likewise be created as a result of the motion of the movable component 7 in the second chamber 12, and the underpressure draws the fluid into the second chamber 12 through at least one second inlet 34, and upon a subsequent motion of the movable component 7 conveys the fluid out of the second chamber 12 through the second outlet 35 to the cleaning element 27 in order to expose the camera unit 1, in particular the lens 28 of the camera unit 1, to the fluid, in particular water. The second inlet 34 is connected to a flexible second inlet line 37 at a second inlet port 36. The second inlet line 37 is connected in a sealed manner by an inlet connecting element, not shown, to the second inlet port 36.

The second outlet 35 is connected to a flexible second outlet line 39 at a second outlet port 38. The second outlet line 39 is likewise connected in a sealed manner by an outlet connecting element, not shown, to the second outlet port 38.

The first inlet line 30 is provided with a check valve 40. The first outlet line 32 is provided with a check valve 41. The second inlet line 37 is provided with a check valve 42. The second outlet line 39 is provided with a check valve 43.

The first outlet line 32 and the second outlet line 39 are connected to one another downstream of the applicable check valves 41, 43 and form a combined outlet 44, in particular a combined outlet line 45, which is connected to the cleaning element 27.

The second inlet line 37 is connected to a water reservoir, in particular a wash water reservoir of the windshield washing system or its lines, in order to ensure the water supply for the cleaning device 2. The first outlet line 32 and the second outlet line 39 are connected to the cleaning element 27 that is implemented as a stationary cleaning nozzle and that exposes the camera unit 1, in particular a lens 28 of the camera unit 1, to a fluid, in particular water and/or air. The cleaning element 27 is immovably attached to the camera housing 5 of the camera unit 1. Alternatively, however, the cleaning element 27 can also be moved by a drive, for example in order to be moved from a protected rest position in the camera housing 5 into a cleaning position for cleaning of the lens 28.

The functioning of the camera unit 1 with the cleaning device 2 is described below using FIGS. 2a to 2d, wherein the cleaning process is carried out on the one hand and the drying process on the other hand. The fluid in the form of water is illustrated using dashes and the fluid in the form of air is visualized using round dots.

When the lens 28 of the camera unit 1 is dirty, the cleaning process can either be started manually by a user or automatically by means of a sensor. Fundamentally, the second chamber 12 is always at least partially filled with a fluid, in particular with water, prior to the start of every camera unit 1 cleaning process.

The cleaning process is described below. In FIG. 2a, the movable component 7, which is implemented as a piston, is in a rest position. The second chamber 12 is filled with water, and the first chamber 11 is filled with outgoing air or incoming air. Outgoing air or incoming air means that the air shown in FIG. 2a is not used for the drying process, but instead is released to the environment through the vent opening 33. This is absolutely necessary, because otherwise the control element 7 would have to compress the air located in the first chamber 11 in FIG. 2a. This would cause the control element 7 to consume a needlessly large amount of energy.

When the cleaning process is started now, the movable component 7 moves from a first position, in particular the rest position, to a second position, in particular the cleaning position, as is shown in FIG. 2b. During the motion from the first position to the second position, the second fluid, in particular water, is transported through the second outlet 35 and through the second outlet line 39 to the cleaning element 27 until the second chamber 12 is essentially free of water, as is illustrated in FIG. 5c. During this process, the check valve 43 of the second outlet line 39 is opened by the rising water pressure, while at the same time the check valve 42 of the second inlet line 37 remains closed. If one considers the first chamber 11, in particular the chamber section A, this section is filled with air during the motion of the movable component 7 from the rest position to the cleaning position. In this process, air is drawn in from the environment through the first inlet line 30. The check valve 40 of the first inlet line 30 opens, and the air flows into the chamber 11, in particular into the chamber section A, while the check valve 41 of the first outlet line 32 remains closed. At the same time, as the movable part 7 moves from the rest position to the cleaning position, the outgoing air in the chamber section B is released to the environment through the vent opening 33.

The cleaning position is fully reached, see FIG. 2c, when the second chamber 12 contains essentially no more water. At exactly this moment, the first chamber 11, in particular the chamber section A, is completely filled with air, as shown in FIG. 2c. Once the camera unit 1 has been cleaned by means of the cleaning element 27, the movable component 7 is moved back to the rest position from the cleaning position automatically by means of a spring element 46 located in control element housing 8 and/or with the aid of the electric actuator. During this motion, shown in FIG. 2d, the fluid is drawn in through the second inlet 34, in particular water is drawn in through the second inlet line 37, wherein the check valve 43 of the second inlet line 39 opens in this process on account of the underpressure arising in the second chamber 12. At the same time, the first fluid, in particular air, is transported through the first outlet 26 to the cleaning element 27 as the movable component 7 moves from the cleaning position into the rest position. Due to the pressure arising in the first outlet line 32, the check valve 41 of the first outlet line 32 is opened and the air flows through the combined outlet line 45 to the cleaning element 27. The check valve 43 of the second outlet line 32 and the check valve 40 of the first inlet line 42 remain closed in this process. In addition, incoming air is supplied through the vent opening 33 to the chamber section B of the first chamber 11 during the motion of the movable part 7 from the cleaning position to the rest position in order to reduce the energy consumption for moving the movable part 7.

The moisture remaining on the camera unit 1, in particular on the lens 28, after the cleaning process that has just taken place, is dried by the air. Once the air has substantially flowed out of the first chamber 11, the movable component is again in the rest position shown in FIG. 2a. The cleaning and drying process is completed, and all check valves 40 to 43 of the cleaning device 2 are closed.

What is claimed is:

1. A camera unit for image acquisition of an outside area for a motor vehicle having a cleaning device provided for cleaning the camera unit, wherein the cleaning device includes:
a control element for driving a movable component, in particular a piston,
a housing for accommodating the movable component, wherein at least one inlet and at least one outlet, each of which is provided with a check valve, is associated with the housing,
a cleaning element, in particular a cleaning nozzle, connected to the at least one outlet, in order to apply at least one fluid to the camera unit,
wherein, as a result of the motion of the movable component, the fluid can be transported from the inlet to the at least one outlet in order to clean the camera unit with the cleaning element,
wherein the housing includes at least two chambers, a first chamber having a greater fill volume than a second chamber.

2. The camera unit according to claim 1, wherein an underpressure can be created as a result of the motion of the movable component in the first chamber, that draws the fluid into the first chamber through at least one first inlet, and upon a subsequent motion of the movable component conveys the fluid out of the first chamber through a first outlet to a cleaning element in order to expose the camera unit, in particular a lens of the camera unit, to the fluid, in particular air.

3. The camera unit according to claim 1, further comprising at least one additional vent opening in the first chamber that serves to fill and empty the first chamber with air.

4. The camera unit according to claim 2, wherein as a result of the motion of the movable component in the second chamber, an underpressure can be created that draws the fluid into the second chamber through at least one second inlet, and upon a subsequent motion of the movable component the fluid is conveyed out of the second chamber through a second outlet to the cleaning element in order to expose the camera unit, in particular a lens of the camera unit, to the fluid.

5. The camera unit according to at least one of claim 1, wherein the first chamber has a first inlet for a first fluid, in particular air, as well as a first outlet for the first fluid, and the second chamber has a second inlet for a second fluid, in particular water, as well as a second outlet for the second fluid.

6. The camera unit according to claim 5, wherein the movable component is designed to be movable between a first position, in particular a rest position, and a second position, in particular a cleaning position, wherein, during the motion from the first position to the second position the second fluid, in particular water, can be transported through the second outlet to the cleaning element, and the first fluid, in particular air, can be drawn in through the first inlet, and during the motion of the movable component from the second position to the first position, the second fluid, in particular water, can be drawn in through the second inlet and the first fluid, in particular air, can be transported to the cleaning element through the first outlet in order to dry the camera unit, in particular a lens of the camera unit.

7. The camera unit according to claim 6, wherein the first chamber is operable to be filled with air and the second chamber is operable to be filled with water, the first chamber being used for disposition of the first fluid, in particular air, and the second chamber being used for disposition of the second fluid, in particular water.

8. The camera unit according to claim 1, wherein the movable component has a first plate and a second plate, wherein the first plate is connected to the second plate by means of a connecting element.

9. The camera unit according to claim 8, wherein the first plate is located in the first chamber, and the second plate is located in the second chamber.

10. The camera unit according to claim 8, wherein the first plate and the second plate are provided with one seal element apiece, the first seal element being located between an inner wall of the first chamber and a plate wall of the first plate, and the second seal element being located between an inner wall of the second chamber and a plate wall of the second plate.

11. The camera unit according to claim 5, wherein the first outlet has a first outlet line and the second outlet has a second outlet line, wherein the first outlet line and the second outlet line are connected to one another downstream of the applicable check valves and form a combined outlet, in particular a combined outlet line that is connected to the cleaning element.

12. The camera unit according to claim 11, wherein the first and second inlet lines and/or the first and second outlet lines and/or the first and second outlets and/or the first and second inlets are made of a flexible material.

13. The camera unit according to claim 6, wherein the movable component is connected to a spring element in order to automatically move the movable component by means of the spring element from the second position, in particular the cleaning position, back to the first position, in particular the rest position.

14. The camera unit according to claim 1, wherein the control element is implemented as an electric motor or actuator.

15. The camera unit according to claim 1, wherein the cleaning device is connected to the camera unit.

16. The camera unit according to claim 1, wherein the cleaning element is arranged in a fixed position on a camera housing of the camera unit.

17. The camera unit according to claim 1, wherein the cleaning element is operable to be moved by a drive.

18. The camera unit according to claim 1, wherein the second chamber is at least partially filled with water prior to the start of the cleaning process for the camera unit.

19. A method for cleaning a camera unit for image acquisition of an outside area for a motor vehicle, wherein a cleaning device that has a cleaning element and that serves to clean the camera unit with a fluid is associated with the camera unit, wherein the cleaning device has a control element that moves a movable component, in particular a piston, within a housing of the cleaning device, which housing is designed with at least one inlet and at least one outlet, wherein the fluid is moved from the inlet to the outlet by the motion of the movable component in order to clean and/or to dry the camera unit with the cleaning element, wherein the housing includes at least two chambers, wherein a first chamber has a greater fill volume for the fluid than a second chamber.

20. The method for cleaning the camera unit according to claim 19, wherein a fluid is drawn in through the inlet during the motion of the movable component, and then upon a second motion is transported through the outlet to the cleaning element in order to clean and/or to dry the camera unit, in particular a lens of the camera unit, with the fluid.

21. The method for cleaning the camera unit according to claim 19, wherein the first chamber has a first inlet and a first outlet for a first fluid, in particular air, and the second chamber has a second inlet and a second outlet for a second fluid, in particular water.

22. The method for cleaning the camera unit according to claim 21, wherein the movable component is operable to be moved between a first position, in particular a rest position, and a second position, in particular a cleaning position, wherein during the motion from the first position to the second position, the second fluid, in particular water, can be transported to the cleaning element through the second outlet, and the first fluid, in particular air, can be drawn in through the first inlet, and during the motion of the movable component from the second position to the first position, the second fluid, in particular water, can be drawn in through the second inlet and the first fluid, in particular air, can be transported to the cleaning element through the first outlet in order to dry the camera unit, in particular a lens of the camera unit.

23. The method for cleaning the camera unit according to claim 22, wherein a spring element is connected to the movable component and is preloaded by the control element during the movement from the first position, in particular the rest position, to the second position, in particular the cleaning position, and after the second chamber has been emptied of the fluid, in particular water, the movable component is automatically conveyed back from the second position to the first position by the preloaded spring element.

24. The method for cleaning the camera unit according to claim 19, wherein the camera unit is first exposed to water and then to air.

25. A cleaning device having the camera unit according to claim 1.

26. A camera module having a cleaning device or a camera unit according to claim 1.
